(19) United States
(12) Patent Application Publication
(10) Pub. No.: US 2014/0016869 A1
(43) Pub. Date: Jan. 16, 2014

(54) SIGNAL PROCESSING APPARATUS AND SIGNAL PROCESSING METHOD

(71) Applicant: Sony Corporation, Tokyo (JP)

(72) Inventors: Taro Ichitsubo, Tokyo (JP); Takashi Hirakawa, Tokyo (JP)

(21) Appl. No.: 13/929,115

(22) Filed: Jun. 27, 2013

(30) Foreign Application Priority Data
Jul. 10, 2012 (JP) 2012-154295

(51) Int. Cl. G06T 5/00

(52) U.S. Cl. CPC G06T 5/002
USPC 382/195

(57) ABSTRACT

A signal processing apparatus includes a representative value calculation unit and a low pass component extraction value calculation unit. The representative value calculation unit is configured to calculate, when areas obtained by dividing a frame image in units of a plurality of pixels are each assumed as a block, an average value of pixel values within each block as a representative value of the block based on an input video signal. The low pass component extraction value calculation unit is configured to perform spline interpolation using the representative values of the blocks located near a pixel being a calculation target for a low pass component extraction value, to calculate the low pass component extraction value of the calculation target.

### BACKGROUND

The present disclosure relates to a signal processing apparatus that performs signal processing on an input video signal and a method therefor, and more particularly, to a technique of extracting a low pass component of a video.

Some video signal processing apparatuses perform LPF (Low Pass Filter) processing on input video signals.

As an example, such LPF processing is executed for so-called dynamic contrast correction in which a gain appropriate to a difference between a pixel value of an input video signal and a value obtained after the LPF processing is imparted to the input video signal, to perform contrast adjustment.

In the dynamic contrast correction, a gain can be applied to a pattern with a high frequency component in a limited way, and accordingly a high contrast image can be generated (see, for example, Japanese Patent Application Laid-open No. 2011-3048).

### SUMMARY

Here, for example, in the dynamic contrast correction as described above, in order to achieve a much higher contrast image, it is necessary to apply a relatively strong LPF (Low Pass Filter) (that is, to apply an LPF with a lower cutoff frequency) to an input video signal.

However, in general, when a strong LPF is applied to an input video signal, a large TAP number (a large number of multipliers) is necessary, which leads to an increase in circuit size.

In other words, data near a target pixel is simply used in a normal LPF, and therefore, as a cutoff frequency of the LPF becomes lower, the TAP number of the filter increases.

Due to such an increase in circuit size, there is a fear that feasible LPF strength is limited.

In view of such a problem, it is desirable to achieve LPF processing for a video signal while suppressing an increase in circuit size.

According to an embodiment of the present disclosure, there is provided a signal processing apparatus configured as follows.

Specifically, a signal processing apparatus according to an embodiment of the present disclosure includes a representative value calculation unit configured to calculate, when areas obtained by dividing a frame image in units of a plurality of pixels are each assumed as a block, an average value of pixel values within each block as a representative value of the block based on an input video signal.

Further, the signal processing apparatus includes a low pass component extraction value calculation unit configured to perform spline interpolation using the representative values of the blocks located near a pixel being a calculation target for a low pass component extraction value, to calculate the low pass component extraction value of the calculation target.

As described above, in the present disclosure, for an input video, an average value of pixel values for each block constituted of a plurality of pixels is obtained, and a low pass component extraction value of a target pixel is obtained by performing spline interpolation using the average values. In other words, the value thus obtained by the spline interpolation is substituted for an output result of the LPF.

By such a low pass component extraction technique according to the embodiments of the present disclosure, a circuit size can be largely reduced compared to a case of a normal LPF (LPF in which pixel values near a target pixel are simply used).

According to the present disclosure, a circuit size can be largely reduced compared to a case of a normal LPF. Accordingly, it is possible to effectively avoid a situation in which the strength of the LPF is restricted in view of the circuit size.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is an explanatory graph on the outline of dynamic contrast correction performed using a low pass component extraction technique according to an embodiment;

FIGS. 2A, 2B, 2C, and 2D are explanatory diagrams on the low pass component extraction technique according to the embodiment;

FIG. 3 is an explanatory diagram on a relationship between a pixel position being a calculation target and an interpolation value readout block;

FIG. 4 is a conceptual diagram of spline interpolation;

FIGS. 5A and 5B are explanatory diagrams on measures for a case where a boundary of an effective video area and boundaries of blocks do not coincide with each other;

FIG. 6 is a diagram exemplifying representative values that are used in spline interpolation for pixel positions at end portions of the effective video area;

FIG. 7 is a diagram showing an example of an extrapolation technique for representative values;

FIG. 8 is a graph exemplifying a function for obtaining a gain from a difference between a luminance value and a low pass component extraction value;

FIGS. 9A and 9B are graphs each exemplifying a function for obtaining a gain from an RGB maximum value;

FIG. 10 is a block diagram showing an internal configuration of a signal processing apparatus according to the embodiment; and

FIG. 11 is a flowchart showing a processing procedure to be executed to achieve the low pass component extraction technique as the embodiment.

### DETAILED DESCRIPTION OF EMBODIMENTS

Hereinafter, an embodiment according to the present disclosure will be described.

It should be noted that description will be given in the following order.

<1. Application Example of Low Pass Component Extraction Technique according to Embodiment>

<2. Low Pass Component Extraction Technique according to Embodiment>

<3. Specific Example of Dynamic Contrast Correction>

<4. Configuration of Signal Processing Apparatus according to Embodiment>

<5. Modified Example>

### 1. Application Example of Low Pass Component Extraction Technique According to Embodiment

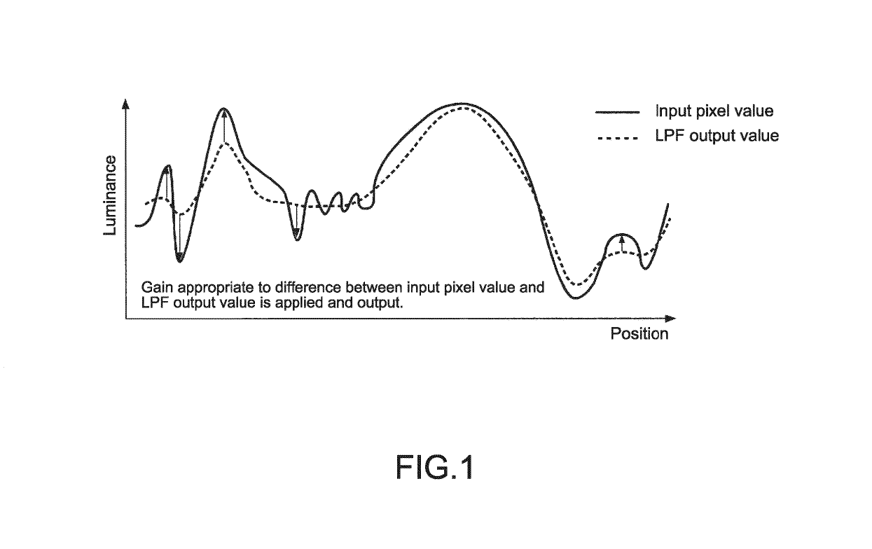

FIG. 1 is an explanatory graph on the outline of dynamic contrast correction performed using a low pass component extraction technique according to an embodiment.

It should be noted that in FIG. 1, with the horizontal axis being as a pixel position and the vertical axis being as a luminance value, an input pixel value (in this case, luminance value) is indicated by a solid line, and an LPF (Low Pass Filter) output value is indicated by a broken line.

In the dynamic contrast correction, first, a difference between an input pixel value and an LPF output value is obtained for each pixel position. In FIG. 1, each arrow in the vertical direction corresponds to a value of the difference.

Then, a gain appropriate to the difference value thus obtained is imparted to an input video signal of a corresponding pixel position.

According to such dynamic contrast correction, a gain can be applied to a pattern with a high frequency component in a limited way, and accordingly a high contrast image can be generated.

In this embodiment, for example, the LPF processing executed in such dynamic contrast correction will be exemplified as LPF processing performed on an input video signal.

It should be noted that specific content on the dynamic contrast correction is described later.

### 2. Low Pass Component Extraction Technique According to Embodiment

Here, when a higher contrast image is intended to be obtained, it is necessary to apply a relatively strong LPF in the dynamic contrast correction. Specifically, for example, it is necessary to apply a relatively strong LPF such as an LPF referring to several tens of adjacent pixels in horizontal and vertical directions (for example, a moving average filter of about 32 horizontal pixels by 32 vertical pixels).

However, in the case where an LPF by a normal technique is simply adopted when the relatively strong LPF such as an LPF referring to several tens of adjacent pixels is applied in horizontal and vertical directions, a TAP number (the number of multipliers) as many as the number of pixels is necessary. At the same time, in order to hold a video in the vertical direction, it is necessary to prepare line memories substantially as many as the number of vertical-direction pixels that are referred to in the LPF.

In these circumstances, it is considered that covering such TAP number or capacity of line memories in a feasible circuit size is extremely difficult. In other words, it is considered that applying the strong LPF as described above in a real circuit size is almost impossible.

In this regard, this embodiment proposes a low pass component extraction technique instead of the normal LPF. The low pass component extraction technique is capable of suppressing an increase in circuit size.

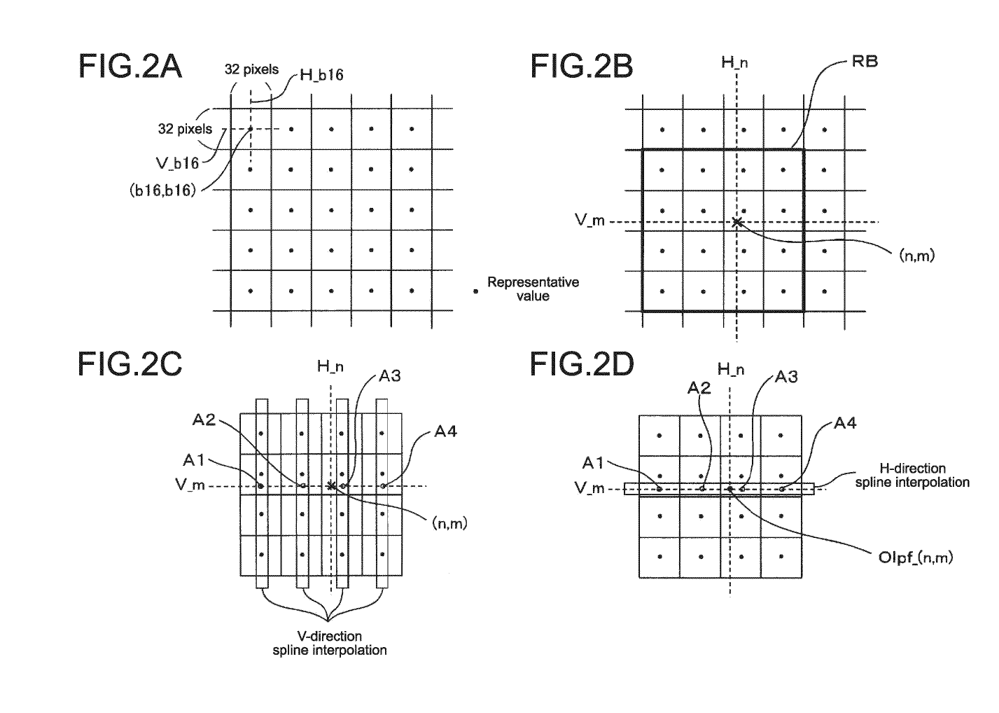

FIGS. 2A, 2B, 2C, and 2D are explanatory diagrams on the low pass component extraction technique according to the embodiment.

First, procedures of the low pass component extraction technique according to the embodiment will be roughly described below.

(Procedure 1)

An input video signal is divided in units of a plurality of pixels, that is, a horizontal pixels by a vertical pixels (in this example, divided in units of 32 horizontal pixels by 32 vertical pixels). Then, an average value of pixel values within each of areas thus obtained (hereinafter, the areas are referred to as blocks) is calculated as a representative value (FIG. 2A).

(Procedure 2)

Spline interpolation is performed using the representative values of the plurality of blocks located near a pixel (having coordinates (n, m) in FIG. 2B) being a calculation target of a low pass component extraction value, to calculate a low pass component extraction value Olpf of the pixel being a calculation target (FIGS. 2C and 2D).

Here, in this description, the position of the pixel being the calculation target of the low pass component extraction value Olpf is represented by the coordinates (n, m). In this case, “n” is a value representing a pixel position (H_n) in the horizontal direction (that is, a value representing distinction from a vertical line), and “m” is a value representing a pixel position (V_m) in the vertical position (that is, a value representing distinction from a horizontal line).

First, (Procedure 1) described above will be specifically described.

In this example, an area including 32 horizontal pixels by 32 vertical pixels is assumed as one block, and a video display area is divided using blocks.

In (Procedure 1) described above, for each of the blocks, an average value of luminance values of pixels constituting the block is obtained as a representative value of the block.

This representative value is managed as a value of the center position of the block. Specifically, for example, the representative value is managed as a value of a pixel position (b16, b16) determined by a 16th pixel position in the horizontal direction (H_b16) and a 16th pixel position in the vertical direction (V_b16) within the block.

In (Procedure 1) described above, the representative value (center value) thus obtained for each block is stored in a predetermined memory.

Subsequently, in (Procedure 2) described above, as the spline interpolation, spline interpolation in the vertical direction shown in FIG. 2C (also referred to as V-direction spline interpolation) and spline interpolation in the horizontal direction based on values obtained in the V-direction spline interpolation (also referred to as H-direction spline interpolation) are performed (FIGS. 2C and 2D).

Specifically, in those spline interpolation, as indicated by a thick frame “RB” in FIG. 2B, representative values of a plurality of blocks located near the pixel position (n, m) being the calculation target of the low pass component extraction value Olpf are read out.

Here, in the execution of the spline interpolation, the plurality of blocks from which the representative values are read out are hereinafter referred to as an “interpolation value readout block RB”.

Here, such an interpolation value readout block RB is determined in accordance with a pixel position being a calculation target.

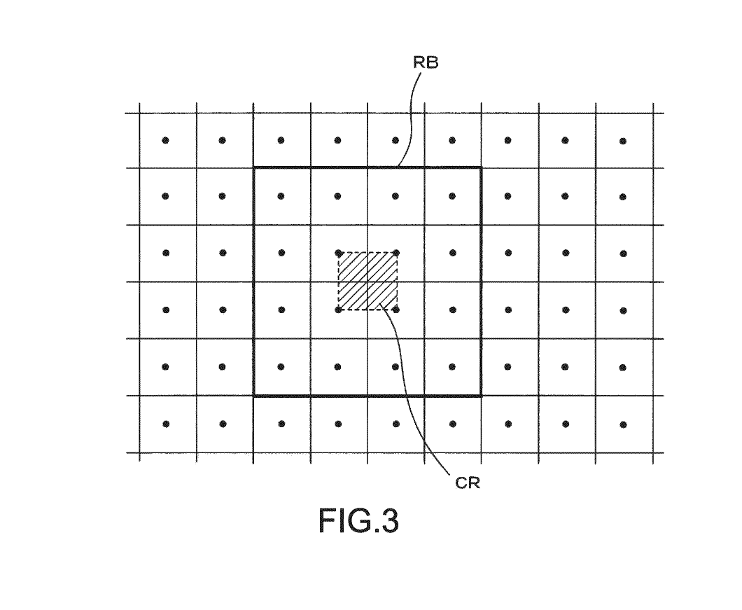

A relationship between a pixel position being a calculation target and an interpolation value readout block RB will be described with reference to FIG. 3.

It should be noted that in FIG. 3, a part of a display screen is divided in units of blocks.

In the spline interpolation, it is assumed that four values are used at minimum ([Expression 1] to be described later).

As shown in FIG. 2D, in the H-direction spline interpolation in which a low pass component extraction value Olpf is eventually calculated, four values are used for the calculation. Therefore, the V-direction spline interpolation shown in FIG. 2C, which is performed before the H-direction spline interpolation, has to be performed at four positions in the horizontal direction.

Therefore, in order to achieve the spline interpolation in this example, it is necessary to use representative values of a total of 16 blocks (4×4=16) to perform the V-direction spline interpolation that should be performed at four positions arranged in the horizontal direction. In other words, the number of blocks of the interpolation value readout block RB is 16 (4×4=16).

As shown in FIG. 3, in the interpolation value readout block RB, its center area CR is set. Specifically, the center area CR is an area formed by connecting the center positions of four blocks of two horizontal blocks by two vertical blocks, the four blocks being formed at the center of the readout block RB. It should be noted that for confirmation, the center position in this example is a pixel position determined by a 16th pixel position in the horizontal direction and a 16th pixel position in the vertical direction within a block as described above.

When the pixel position (n, m) being the target is located within the center area CR thus determined, an interpolation value readout block RB including the center area CR is selected (determined) as a readout block RB corresponding to the pixel position (n, m) being the target.

Description will be returned to FIG. 2.

In execution of the V-direction spline interpolation shown in FIG. 2C, representative values of respective blocks constituting the interpolation value readout block RB, which is determined based on the pixel position (n, m) being the calculation target as described above, are read out from the memory described above.

Then, the 16 representative values thus read out are used to perform the vertical-direction spline interpolation at four positions arranged in the horizontal direction, thus obtaining values (low pass component extraction values) at four positions on the same horizontal line as that of the pixel position (n, m) being the target.

Specifically, assuming that four blocks arrayed in the vertical direction within the interpolation value readout block RB are considered as a “column”, spline interpolation using the four representative values is performed for each of the four “columns”.

Thus, low pass component extraction values at four positions are obtained. The low pass component extraction values are determined based on the center position in each column (in this example, 16th pixel position in the horizontal direction of the blocks constituting that column) and a pixel position (V_m) in the vertical direction at the pixel position (n, m) being the target. Those low pass component extraction values at four positions (result values of V-direction spline interpolation) are denoted by A1, A2, A3, and A4 from the left.

For confirmation, specific content of the spline interpolation will be described here.

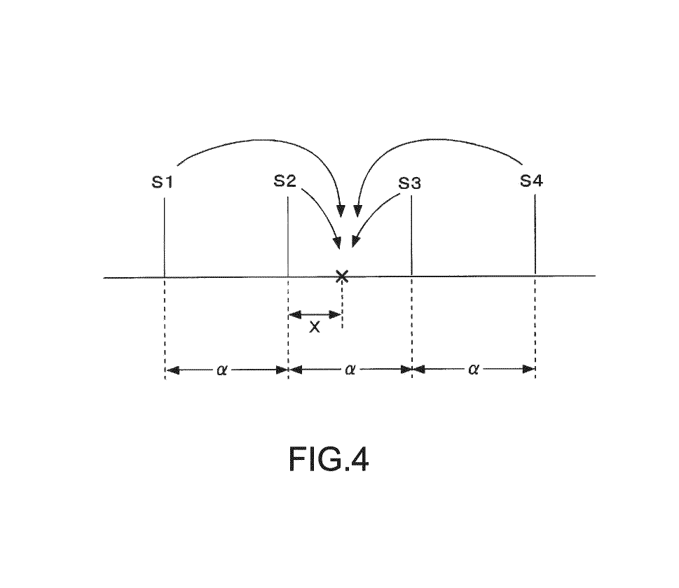

FIG. 4 is a conceptual diagram of the spline interpolation.

As shown in FIG. 4, the spline interpolation is an interpolation technique of using four signal values S1 to S4 arranged at regular intervals a to calculate a signal value of an arbitrary position between a signal value S2 and a signal value S3 that are located at the center.

Here, assuming that a distance from the signal value S2 to an arbitrary position being a calculation target (indicated by a cross in FIG. 4) is “X”, spline interpolation (blend spline) is performed by the following Expression 1 using the value of “X” and the signal values S1, S2, S3, and S4. It should be noted that in this example, α is 32 as understood from the above description.

$$Blend Spline = - \frac{1}{6 \times {α}^{3}} \{ ( X + 0 ) \times ( X - α ) \times ( X - 2 α ) \} \times S 1 + \frac{1}{2 \times {α}^{3}} \{ ( X + α ) \times ( X - α ) \times ( X - 2 α ) \} \times S 2 - \frac{1}{2 \times {α}^{3}} \{ ( X + α ) \times ( X + 0 ) \times ( X - 2 α ) \} \times S 3 + \frac{1}{6 \times {α}^{3}} \{ ( X + α ) \times ( X + 0 ) \times ( X - α ) \} \times S 4 \qquad [ Expression 1 ]$$

Description will be returned to FIG. 2.

After the V-direction spline interpolation expressed by Expression 1 above is performed to obtain the pixel position (n, m) being the target and the four values (A1 to A4) on the same horizontal line, the H-direction spline interpolation shown in FIG. 2D is performed. Specifically, spline interpolation in the horizontal direction is performed using those result values A1 to A4 of the V-direction spline interpolation, thus obtaining a low pass component extraction value Olpf of the pixel position (n, m) being the target.

It should be noted that the H-direction spline interpolation is performed by Expression 1 with the values S1 to S4 to be used being set to A1 to A4.

Here, in this example, representative values calculated from an input video signal of a current frame are not used as the representative values to be used in the spline interpolation as described above, and representative values calculated from an input video signal of a frame one frame before are used as the representative values.

Thus, reduction in memory capacity to be used is achieved.

In the dynamic contrast correction of this example to be described later, in determination of a gain to be imparted to each pixel position, an luminance value of an input video signal and a low pass component extraction value Olpf calculated by the low pass component extraction technique of this example are compared in units of pixels.

Under this assumption, when representative values calculated for the input video signal of the current frame are used, it is necessary to prepare a memory that stores pixel values corresponding to one frame of the input video signal.

Assuming that representative values calculated for an input video signal of a frame one frame before are used for the spline interpolation as in this example, a memory capacity to be used only needs to be a capacity corresponding to the number of blocks constituting one screen. In this regard, the memory capacity to be used can be reduced.

It should be noted that according to the technique using representative values of an image one frame before for the spline interpolation as described above, a low pass component extraction value of an image one frame before and a luminance value of a current frame are compared with each other. Therefore, it can be said that this comparison is not exact in a narrow sense. However, in practical use, it is confirmed that a significant problem such as degradation of an image does not occur.

For confirmation, the above-mentioned low pass component extraction processing in this example is executed for pixels within an effective video area.

At this time, the fact that a boundary of an effective video area does not necessarily coincide with boundaries of blocks should be considered.

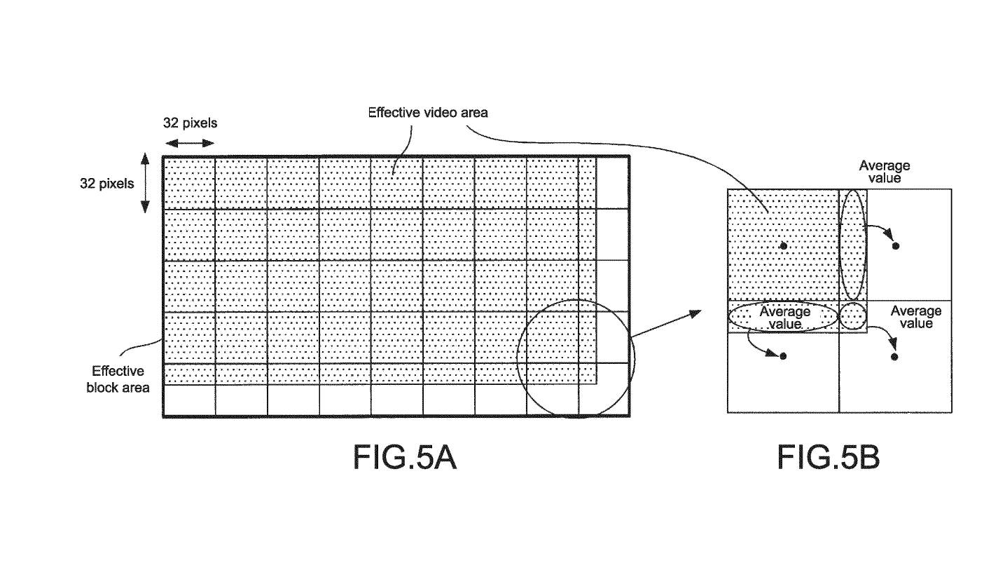

FIG. 5A shows a case where the boundary of an effective video area (screened part in FIG. 5A) does not coincide with the boundaries of the blocks. In such a case, as shown in FIG. 5B, an average value of pixel values (in this example, luminance values) of effective pixels within each of the blocks to which the boundary of the effective video area belongs is calculated as a representative value of the block. Then, the average value is stored in the memory.

Hereinafter, the aggregate of the blocks in which representative values are calculated from pixel values within the effective video area is referred to as an “effective block area”, as indicated by a thick frame of FIG. 5A.

Incidentally, according to the technique of the spline interpolation described above, it is found that when the spline interpolation (calculation of low pass component extraction value Olpf) is performed, representative values located outside the effective video area have to be used regarding pixel positions located near the end portions of the effective video area.

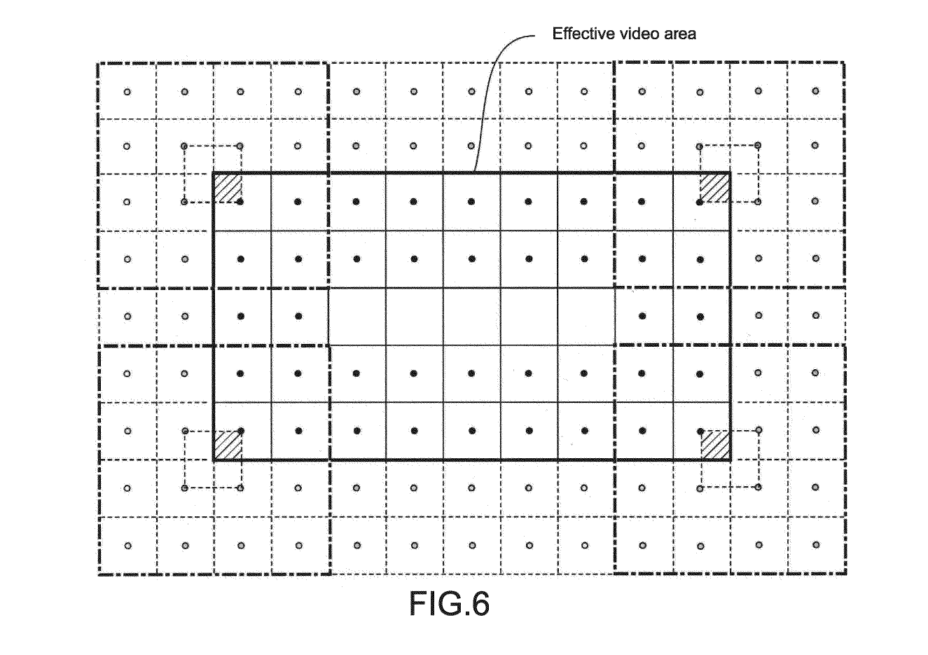

FIG. 6 shows an example of the representative values (in FIG. 6, indicated by black and gray circles) that are used to calculate low pass component extraction values Olpf regarding pixel positions near the end portions of the effective video area.

Among those circles, the black circles represent representative values calculated based on pixel values within the effective video area.

It should be noted that for simple illustration in FIG. 6, the boundary of the effective video area and the boundaries of blocks are assumed to coincide with each other.

FIG. 6 shows the interpolation value readout blocks RB indicated by dashed-line frames. The interpolation value readout blocks RB are used to calculate low pass component extraction values Olpf, by spline interpolation, for pixel positions of four corner portions of the effective video area.

As understood from the above, when a low pass component extraction value Olpf is calculated for each of the pixel positions of the four corner portions, it is necessary to use not only four representative values calculated from pixel values within the effective video area (that is, black circles in each dashed-line frame) but also a total of 12 representative values of blocks including two blocks outside each side of the effective video area (that is, gray circles in each dashed-line frame).

Further, though not shown in FIG. 6, in order to calculate a low pass component extraction value Olpf for a pixel position near an upper end portion of the effective video area, it is also necessary to use representative values of blocks including two blocks outside the upper side of the effective video area. In other words, in the case of FIG. 6, a total of 10 representative values (gray circles) between the two upper dashed-line frames are further used. Further, as in the case of the lower side of the effective video area, in order to calculate a low pass component extraction value Olpf for a pixel position near a lower end portion of the effective video area, it is necessary to use representative values of blocks including two blocks outside the lower side of the effective video area. In the case of FIG. 6, a total of 10 representative values (gray circles) between the two lower dashed-line frames are further used.

Additionally, in order to calculate a low pass component extraction value Olpf for a pixel position near a left-side end portion of the effective video area, it is necessary to use representative values of blocks including two blocks outside the left side of the effective video area (in the case of FIG. 6, two representative values between the two left dashed-line frames are further used). In order to calculate a low pass component extraction value Olpf for a pixel position near a right-side end portion of the effective video area, it is necessary to use representative values of blocks including two blocks outside the right side of the effective video area (in the case of FIG. 6, two representative values between the two right dashed-line frames are further used).

As described above, when the low pass component extraction values Olpf are calculated for all the pixel positions within the effective video area by the spline interpolation described above, it is necessary to use representative values of blocks including two blocks outside each end of the effective video area, together with all the representative values calculated from the pixel values within the effective video area (that is, black circles in FIG. 6).

The representative values of two blocks outside the end of the effective video area are extrapolated based on the representative values calculated from pixel values within the effective video area.

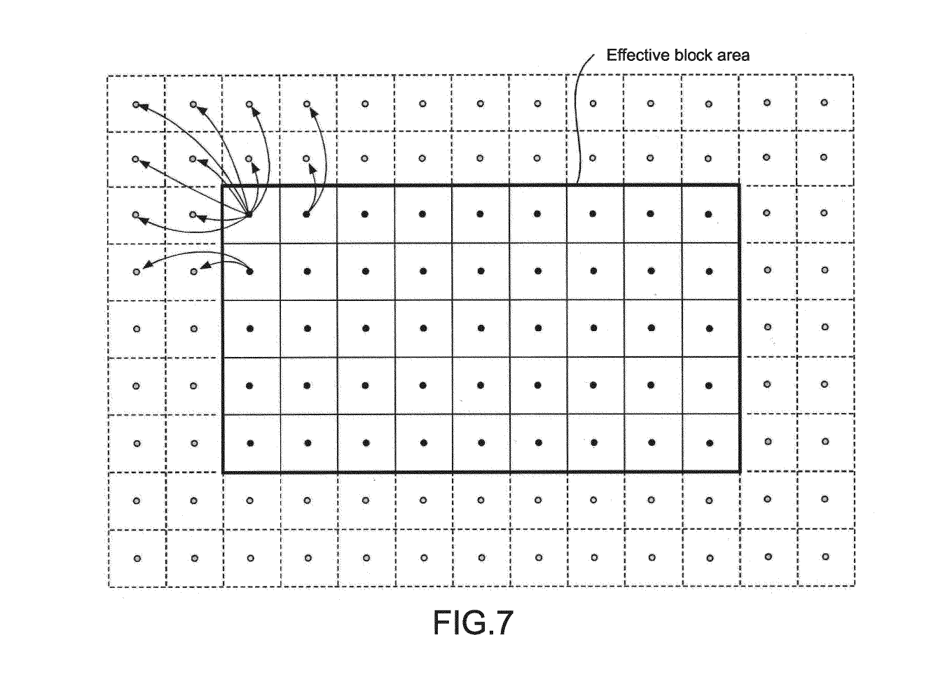

Specifically, as shown in FIG. 7 in this example, the representative values of the blocks at the end portion of the effective block area are extrapolated without change.

More specifically, in this example, among the representative values within the effective block area, representative values located closest to the two blocks outside the end of the effective video area are extrapolated without change. In other words, among the blocks within the effective block area, representative values of blocks whose center positions are located closest to the two blocks outside the end of the effective video area are extrapolated without change.

It should be noted that the extrapolation technique is not limited to the above, and needless to say, other techniques (for example, techniques using quadratic approximation or the like) may be adopted.

According to the low pass component extraction technique of the embodiment described above, a value obtained by the spline interpolation is substituted for an LPF output result. Thus, a circuit size can be largely reduced compared to the case of a normal LPF (LPF in which pixel values near a target pixel are simply used).

Specifically, in the case of this example, when an LPF at the same strength is performed, a TAP number (the number of multipliers) corresponding to 32 pixels and line memories corresponding to 31 lines for holding 32 vertical pixels can be reduced compared to the normal LPF.

By the reduction of the circuit size in such a manner, it is possible to effectively avoid a situation in which the strength of an LPF is restricted in view of the circuit size.

Further, in this embodiment, representative values one frame before are used as the representative values used in spline interpolation. Accordingly, a frame memory for storing an input video signal corresponding to one frame can be omitted.

### 3. Specific Example of Dynamic Contrast Correction

In this embodiment, the low pass component extraction value Olpf obtained by the low pass component extraction technique described above is used for the dynamic contrast correction, the outline of which has been described with reference to FIG. 1.

As described above, the dynamic contrast correction is to impart a gain to an input video signal. The gain is determined based on a difference between a pixel value of each pixel and a low pass component extraction value Olpf.

Here, a luminance value or an RGB maximum value (maximum absolute value of RGB signal; hereinafter, also referred to as maximum value RGBmax) can be used as the pixel value. In the following description, a case where a luminance value (hereinafter, referred to as luminance value Y) is used as the pixel value will be exemplified.

In this example, the following technique is specifically adopted as a technique of the dynamic contrast correction.

(Procedure 3)

For a target pixel, a difference Y-Y′ between a luminance value Y of the pixel and a low pass component extraction value Olpf (hereinafter, also referred to as luminance average value Y′) thereof is calculated.

(Procedure 4)

Based on the difference Y-Y′ and a first gain derivation function, a preliminary gain Gpre (hereinafter, referred to as first gain candidate value Gpre) to be imparted to the target pixel is obtained.

(Procedure 5)

Based on the RGB maximum value (maximum value RGBmax) of the target pixel and a second gain derivation function, a comparison gain Gth (hereinafter, referred to as second gain candidate value Gth) is obtained.

(Procedure 6)

Of the first gain candidate value Gpre and the second gain candidate value Gth, a smaller one is determined as a final gain G to be imparted to the target pixel, and the gain G is imparted to a video signal of the target pixel.

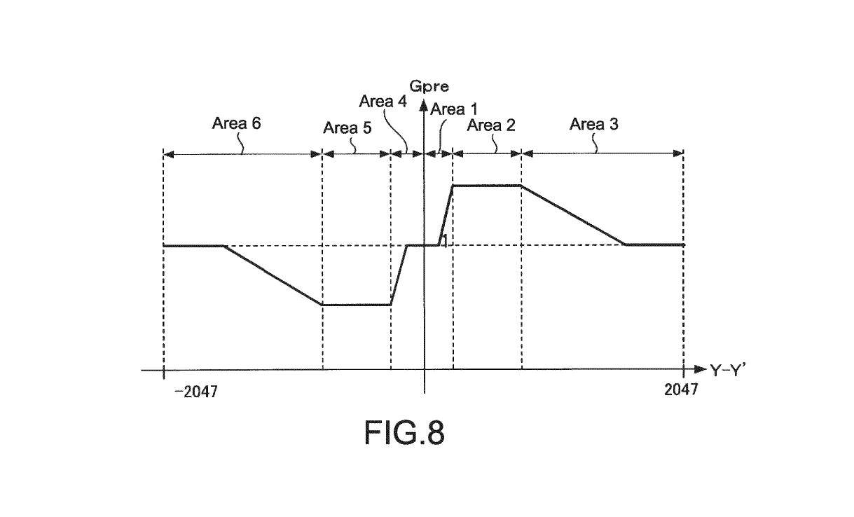

FIG. 8 shows an example of the first gain derivation function used in (Procedure 4) described above.

In the first gain derivation function of this example, as shown in FIG. 8, areas are divided in accordance with the magnitude of the value of the difference Y-Y′. Specifically, an area in which the value of the difference Y-Y′ is positive is divided into three areas 1, 2, and 3 in order of increasing values. Further, an area in which the value of the difference Y-Y′ is negative is divided into three areas 4, 5, and 6 in order of decreasing values (in order of increasing absolute values).

It can be said that the areas 1 and 4 are areas with a small luminance difference, the areas 2 and 5 are areas with a certain degree of a luminance difference, and the areas 3 and 6 are areas with a large luminance difference.

In the areas on the positive side, the area 1 is an area in which the gain Gpre is increased from 1 to the maximum value in accordance with the magnitude of the value of the difference Y-Y′, the area 2 is an area in which the gain Gpre is the maximum value irrespective of the magnitude of the value of the difference Y-Y′, and the area 3 is an area in which the gain Gpre is lowered from the maximum value to 1 in accordance with the magnitude of the value of the difference Y-Y′.

Further, in the areas on the negative side, the area 4 is an area in which the gain Gpre is lowered from 1 to the minimum value in accordance with the magnitude of the value of the difference Y-Y′, the area 5 is an area in which the gain Gpre is the minimum value irrespective of the magnitude of the value of the difference Y-Y′, and the area 6 is an area in which the gain Gpre is increased from the minimum value to 1 in accordance with the magnitude of the value of the difference Y-Y′.

In the case of this example, in the area 3, the value of the gain Gpre is lowered to 1 before the value of the difference Y-Y′ reaches the maximum value (in this case, 2047). Similarly, also in the area 6, the value of the gain Gpre is increased to 1 before the value of the difference Y-Y′ reaches the minimum value (in this case, −2047).

By the setting of the first gain derivation function as described above, a correction to obtain a high contrast image while preventing blown-out highlights or blocked-up shadows can be achieved as the dynamic contrast correction.

In particular, the gain Gpre is suppressed in the area 3, which prevents blown-out highlights from occurring, and the gain Gpre is suppressed in the area 6, which prevents blocked-up shadows from occurring.

It should be noted that in this example, in the areas 1 and 3, the gain is kept to be 1 until the absolute value of the difference Y-Y′ reaches a predetermined value, which can suppress the gain when the difference between the input pixel value and the average value is small and can prevent the image from being unnatural.

Here, parameters for setting the first gain derivation function (length, inclination, and the like of the areas 1 to 6) are set to be programmable with use of a register or the like included in a system.

For convenience of description, in FIG. 8, the shape of a gain curve in the areas 1 to 3 and that in the areas 4 to 6 are symmetrical. However, when the shapes are completely symmetrical, there is a fear that an image in which white is emphasized is obtained.

Parameters for setting a gain curve are set to be programmable so that the shape of the gain curve in the areas 1 to 3 and that in the areas 4 and 6 can be set to be asymmetrical.

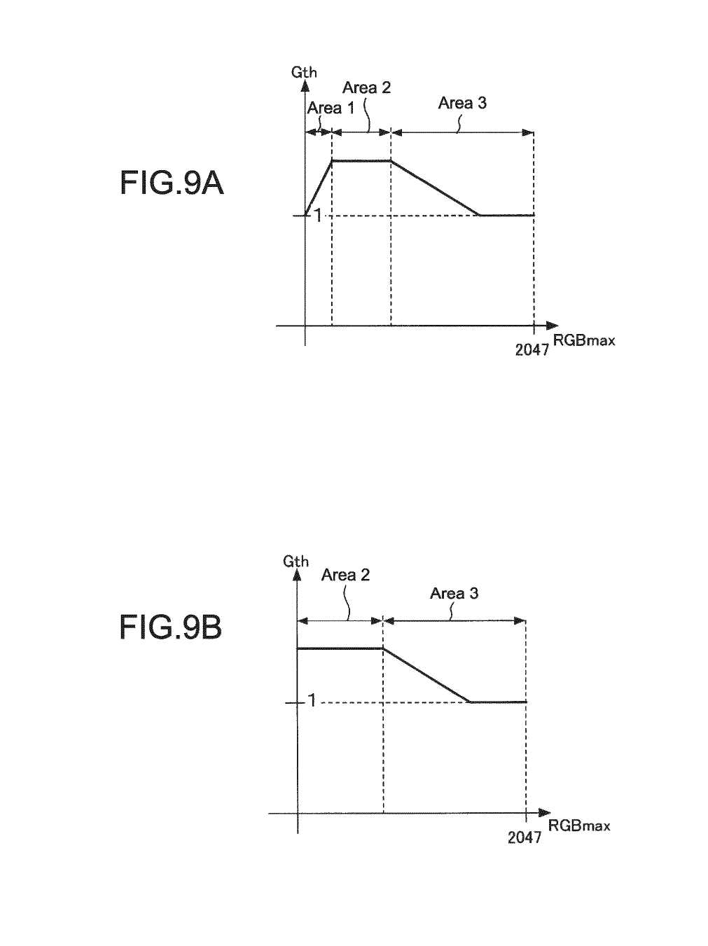

FIGS. 9A and 9B each show an example of the second gain derivation function used in (Procedure 5) described above.

First, in the example of FIG. 9A, areas are divided into three areas 1, 2, and 3 in accordance with the magnitude of the value of the maximum value RGBmax. The areas are set to areas 1, 2, and 3 in order of increasing maximum value RGBmax.

In the area 1, as the value of the maximum value RGBmax increases, the value of the gain Gth is gradually increased from 1 to the maximum value. In the area 2, the gain Gth is 1 irrespective of the value of the maximum value RGBmax. In the area 3, the value of the gain Gth is set to be smaller than the value of the area 2. Specifically, in the area 3 in this case, the value of the gain Gth is lowered to 1 before the value of the maximum value RGBmax reaches the maximum value (in this case, 2047).

According to the second gain derivation function shown in FIG. 9A, the gain Gth is suppressed in the area in which the value of the maximum value RGBmax is large (area 3), that is, the area in which brightness is large. Thus, blown-out highlights are prevented from occurring.

Further, the gain Gth is suppressed in the area in which the value of the maximum value RGBmax is small (area 1), that is, the dark area. Accordingly, black floating is prevented from occurring, and thus a contrast feeling is prevented from being lowered.

It should be noted that in order to prevent only blown-out highlights from occurring, as shown in FIG. 9B, a function in which the area 1 of FIG. 9A is omitted can be used as the second gain derivation function.

In the dynamic contrast correction of this example as described above, a final gain G is determined based on the first gain candidate value Gpre obtained from the value of the difference Y-Y′ and the first gain derivation function shown in FIG. 8, and based on the second gain candidate value Gth obtained from the value of the maximum value RGBmax and the second gain derivation function shown in FIGS. 9A and 9B.

Specifically, of the first gain candidate value Gpre and the second gain candidate value Gth, a smaller one is set as the final gain G.

In such a manner, the value of the maximum value RGBmax (that is, a value simply indicating brightness of the pixel) is taken into consideration for the determination of the final gain G. Thus, it is possible to more reliably prevent blown-out highlights from occurring.

Further, in the case where the function shown in FIG. 9A is used, black floating is prevented from occurring.

It should be noted that as understood from the above, the second gain candidate value Gth can be generated also using the luminance value Y, instead of the maximum value RGBmax. In this case, the second gain derivation function is set such that a corresponding gain Gth is obtained in accordance with the value of the luminance value Y.

### 4. Configuration of Signal Processing Apparatus According to Embodiment

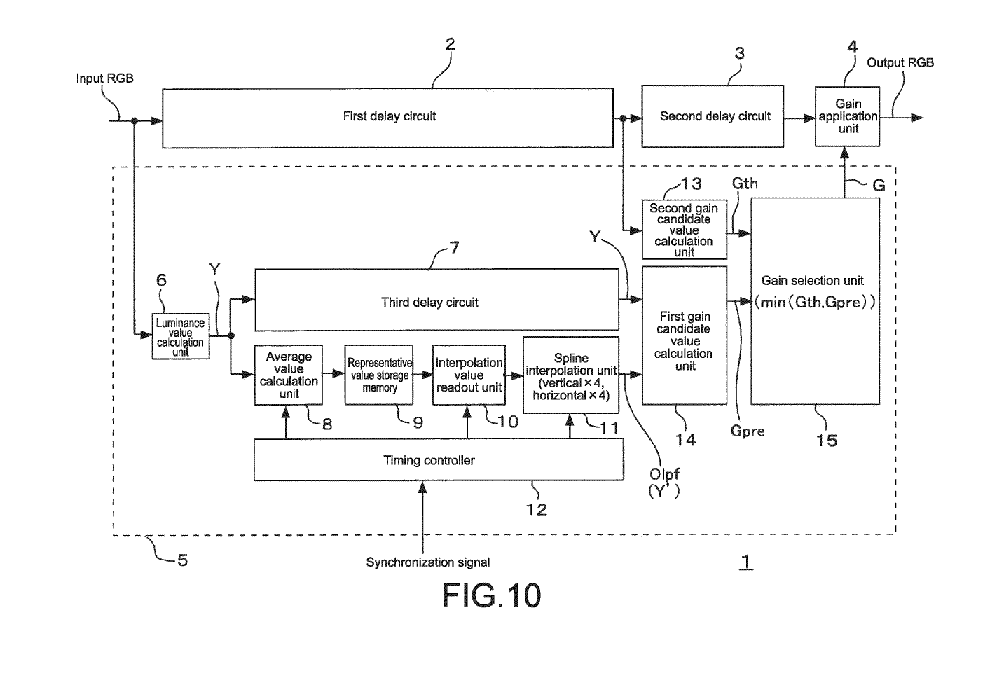

FIG. 10 is a block diagram showing an internal configuration of a signal processing apparatus 1 according to the embodiment, in which the low pass component extraction and dynamic contrast correction described hereinabove are achieved.

As shown in FIG. 10, the signal processing apparatus 1 includes a first delay circuit 2, a second delay circuit 3, a gain application unit 4, and a gain calculation unit 5.

An RGB signal is input (in FIG. 10, input RGB) as an input video signal to the signal processing apparatus 1.

The RGB signal is input to the first delay circuit 2 and the gain calculation unit 5.

The RGB signal transmitted through the first delay circuit 2, the second delay circuit 3, and the gain application unit 4 in the stated order is to be a main line signal. The gain application unit 4 applies a gain G obtained in the gain calculation unit 5 to the RGB signal serving as the main line signal, thus achieving the dynamic contrast correction described above.

The gain calculation unit 5 includes, as shown in FIG. 10, a luminance value calculation unit 6, a third delay circuit 7, an average value calculation unit 8, a representative value storage memory 9, an interpolation value readout unit 10, a spline interpolation unit 11, a timing controller 12, a second gain candidate value calculation unit 13, a first gain candidate value calculation unit 14, and a gain selection unit 15.

The luminance value calculation unit 6 calculates a luminance value Y based on the input RGB signal. The luminance value Y is delayed in the third delay circuit 7 and thereafter input to the first gain candidate value calculation unit 14. Simultaneously, the luminance value Y is input to the average value calculation unit 8 as shown in FIG. 10.

The average value calculation unit 8 calculates an average value of the luminance value Y in units of blocks described with reference to FIG. 2 and the like (in this example, in units of blocks of 32 horizontal pixels by 32 vertical pixels), based on a timing signal from the timing controller 12. Thus, a representative value for each block is obtained.

Here, the timing controller 12 generates a timing signal indicating a pixel position of a current processing target based on an input synchronization signal (for example, a signal indicating a frame period or an effective video area) and supplies the timing signal to the average value calculation unit 8, the interpolation value readout unit 10, and the spline interpolation unit 11.

Luminance values Y of respective pixels constituting one frame are input in a scanning manner from the luminance value calculation unit 6 to the average value calculation unit 8. In other words, the luminance values Y of the respective pixels are input sequentially from a pixel at the leftmost and uppermost position to a pixel at the rightmost and lowermost position.

The average value calculation unit 8 calculates, for each row, representative values of blocks based on the luminance values Y thus input in a scanning manner.

Specifically, at the time of input of the first line of one frame, the average value calculation unit 8 integrates the luminance values Y in order of input in a break of every 32 horizontal pixels (that is, the break of a block). Then, at the time of input of the second line, in a break of every 32 horizontal pixels as in the case of the first line, input luminance values Y are further integrated with the integration result values obtained in the previous line.

In such a manner, such processing of integrating luminance values Y in input order in the break of every 32 horizontal pixels is performed for 32 lines. Then, the thus-obtained integration result values of every 32 horizontal pixels are each divided by 1024 (equal to 32 by 32). Thus, representative values of the respective blocks corresponding to one line are obtained.

It should be noted that for confirmation, a memory that is necessary at this time is a memory for holding one integration result value for each block. A total capacity of the memory is a capacity corresponding to the total number of blocks in one row (for example, a capacity corresponding to 60 pixels in the case of 1920 pixels in the horizontal direction). In this regard, it can be understood that line memories corresponding to 31 lines, which have been used in an LPF in related art, are unnecessary.

The average value calculation unit 8 repeatedly performs the above-mentioned calculation of representative values of respective blocks in one row and obtains representative values for all the blocks.

At this time, each time the average value calculation unit 8 finishes calculating the representative values of the respective blocks in one row in accordance with the input of the luminance values corresponding to 32 lines, the average value calculation unit 8 updates representative values (representative values one frame before) of one corresponding row, which are stored in the representative value storage memory 9, using the calculated representative values.

By repeating of such update in units of 32 lines, the average value calculation unit 8 sequentially updates values of a previous frame, which are stored in the representative value storage memory 9, to values of a current frame.

It should be noted that after the update of the representative value storage memory 9 is performed in units of 32 lines, in the spline interpolation, the representative values calculated from an image of the previous frame and the representative values calculated from an image of the current frame are mixed for use (when the target pixel position reaches the 33rd line and thereafter). However, even when the representative values of the previous frame are used as described above, in practical use, a significant problem such as degradation of an image does not occur.

Here, in order to prevent the representative values calculated from the image of the previous frame and the representative values calculated from the image of the current frame from being mixed for use in the spline interpolation, an update timing of the representative value storage memory 9 may be delayed for a time period corresponding to a predetermined number of lines.

For example, according to the size of the interpolation value readout block RB described with reference to FIG. 3, the representative values in the uppermost row, which are stored in the representative value storage memory 9, are used until the target pixel position reaches the last pixel position in the 79th line (32+32+15=79). In order that the average value calculation unit 8 calculates representative values in the uppermost row regarding the current frame, a time period corresponding to 32 lines is necessary. Thus, in order to prevent the representative values of the previous frame and the representative values of the current frame from being mixed for use in the spline interpolation, it only needs to wait for a time period corresponding to 47 lines (79−32=47) before the representative values in the uppermost row that are stored in the representative value storage memory 9 are updated.

As understood from the above, in order to prevent the representative values of the previous frame and the representative values of the current frame from being mixed for use, the average value calculation unit 8 only needs to wait for a time period corresponding to 47 lines after calculating representative values of one row based on luminance values Y of the current frame, and then update representative values of a corresponding row in the representative value storage memory 9.

It should be noted that in this case, for the representative values of two lowermost rows, the average value calculation unit 8 updates corresponding values in the representative value storage memory 9 according to the spline interpolation performed on the last pixel position on the last line without waiting for a time period corresponding to 47 lines, so that the update of the representative value storage memory 9 is completed within a processing time of the current frame.

The interpolation value readout unit 10 reads out a representative value from the representative value storage memory 9 based on the timing signal from the timing controller 12. The read-out representative value is used to calculate a low pass component extraction value Olpf of a current pixel position.

Specifically, as described with reference to FIG. 3, since the interpolation value readout block RB corresponding to the current pixel position is determined, representative values of 16 blocks as the interpolation value readout block RB are acquired.

Here, in the case where representative values outside the effective video area are used as described above with reference to FIG. 6, the interpolation value readout unit 10 extrapolates those representative values based on the representative values read out from the representative value storage memory 9 (representative values calculated from luminance values Y of pixels within the effective video area). Thus, 16 representative values to be used are acquired.

The spline interpolation unit 11 performs, based on the 16 representative values obtained in the interpolation value readout unit 10, the V-direction spline interpolation described above four times and the H-direction spline interpolation using four values obtained in the above V-direction spline interpolation, thus obtaining a low pass component extraction value Olpf (luminance average value Y′) of the target pixel position.

The spline interpolation unit 11 calculates the luminance average value Y′ (Olpf) at a timing corresponding to a timing signal instructed by the timing controller 12 and sequentially outputs the luminance average value Y′ (Olpf) to the first gain candidate value calculation unit 14.

The first gain candidate value calculation unit 14 calculates a difference Y-Y′ based on the luminance average value Y′ of the target pixel position, which has been obtained in the spline interpolation unit 11, and on the luminance value Y of the same pixel position, which has been input via the third delay circuit 7. Then, based on the difference Y-Y′ and the first gain derivation function described above with reference to FIG. 8, the first gain candidate value calculation unit 14 calculates a first gain candidate value Gpre.

Further, the second gain candidate value calculation unit 13 calculates a second gain candidate value Gth based on an RGB signal value of the target pixel position, which is obtained via the first delay circuit 2, and on the second gain derivation function described above with reference to FIGS. 9A and 9B. Specifically, the second gain candidate value calculation unit 13 calculates a maximum value RGBmax (maximum absolute value of RGB signal) of the target pixel position based on the RGB signal value obtained via the first delay circuit 2 and obtains a second gain candidate value Gth based on the maximum value RGBmax and the second gain derivation function.

The gain selection unit 15 selects a smaller value from the first gain candidate value Gpre obtained in the first gain candidate value calculation unit 14 and the second gain candidate value Gth obtained in the second gain candidate value calculation unit 13, as a final gain G (in FIG. 10, min(Gpre,Gth)). Then, the gain selection unit 15 applies the gain G to the gain application unit 4.

Thus, the gain application unit 4 applies the gain G to the RGB signal of the target pixel position.

The RGB signal to which the gain G is applied in the gain application unit 4 is output to the outside of the signal processing apparatus 1 as a result of the dynamic contrast correction (in FIG. 10, output RGB).

It should be noted that for confirmation, a delay time of the first delay circuit 2 should be appropriately adjusted such that the first gain candidate value Gpre and the second gain candidate value Gth of the same pixel position are compared with each other in the gain selection unit 15, in consideration of a time period for calculating the second gain candidate value Gth in the second gain candidate value calculation unit 13 and a time period for calculating the first gain candidate value Gpre in the first gain candidate value calculation unit 14.

Further, a delay time of the second delay circuit 3 should be appropriately adjusted such that the gain G obtained for the target pixel position in the gain selection unit 15 is applied to the RGB signal of the target pixel position in the gain application unit 4.

Furthermore, a delay time of the third delay circuit 7 should be appropriately adjusted such that a difference between a luminance value Y and an average luminance value Y′ of the same pixel position is calculated in the first gain candidate value calculation unit 14.

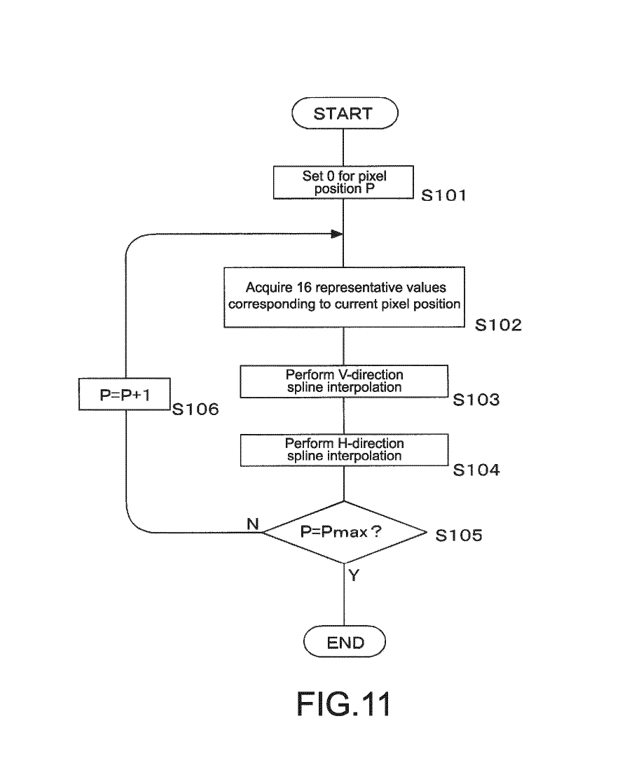

For confirmation, FIG. 11 shows a flowchart of a processing procedure to be executed to achieve the low pass component extraction technique serving as the embodiment.

It should be noted that in FIG. 11, a procedure of processing to be executed for each frame is shown.

Further, in FIG. 11, description on calculation processing of a representative value for each block by the average value calculation unit 8 and storage processing (update processing) of the representative value in the representative value storage memory 9 is omitted.

First, in Step S101, a pixel position P is reset to an initial value “0”.

Then, in the subsequent Step S102, 16 representative values corresponding to the current pixel position are acquired. In other words, this processing corresponds to processing of the interpolation value readout unit 10 to acquire 16 representative values corresponding to the current pixel position based on the representative values stored in the representative value storage memory 9 (in the case where extrapolation is necessary, extrapolation is performed).

After the 16 representative values are acquired in Step S102, the V-direction spline interpolation is performed in Step S103. In other words, this processing corresponds to processing of the spline interpolation unit 11 to execute V-direction spline interpolation of four columns based on the 16 representative values acquired in the interpolation value readout unit 10 and to obtain the values of A1 to A4 described above with reference to FIG. 2C (values at four positions on the same horizontal line as that of the target pixel position).

After the V-direction spline interpolation is executed, the H-direction spline interpolation is performed in Step S104. This processing corresponds to calculation by the spline interpolation unit 11 to calculate a low pass component extraction value Olpf of the target pixel position by the spline interpolation using the four values of A1 to A4.

After the low pass component extraction value Olpf is calculated by the H-direction spline interpolation, whether the target pixel position is the last pixel position (P=Pmax) or not is determined in Step S105.

In the case where it is determined that the target pixel position is not the last pixel position, the value of the pixel position P is incremented by 1 (P=P+1) in Step S106, and then the processing returns to Step S102. Thus, a low pass component extraction value Olpf of the next pixel position is calculated by the spline interpolation.

On the other hand, in the case where it is determined that the target pixel position is the last pixel position, the low pass component extraction processing corresponding to one frame shown in FIG. 11 is terminated.

### 5. Modified Example

Hereinabove, the embodiment of the present disclosure has been described, but the present disclosure is not limited to the specific examples described hereinabove.

For example, in the above description, the case where α=32 and one block is constituted of 32 horizontal pixels by 32 vertical pixels has been exemplified, but the value of α is not limited thereto. Increasing the number of pixels constituting one block corresponds to application of a stronger LPF.

Further, the number of horizontal pixels and the number of vertical pixels of the block should not be limited to the same number.

In addition, the size of each block may not be limited to the same size. Blocks having a different size may exist.

In the above description, the representative value of a block is calculated based on the luminance values Y. However, the representative value may be calculated based on the maximum value RGBmax (that is, an average value of maximum values RGBmax of pixels within a block may be set to a representative value).

Further, the present disclosure can adopt the following configurations.

### (1) A Signal Processing Apparatus, Including:

a representative value calculation unit configured to calculate, when areas obtained by dividing a frame image in units of a plurality of pixels are each assumed as a block, an average value of pixel values within each block as a representative value of the block based on an input video signal; and

a low pass component extraction value calculation unit configured to perform spline interpolation using the representative values of the blocks located near a pixel being a calculation target for a low pass component extraction value, to calculate the low pass component extraction value of the calculation target.

(2) The signal processing apparatus according to (1), in which

the low pass component extraction value calculation unit performs spline interpolation using representative values of 16 blocks of four horizontal blocks by four vertical blocks that are located near the pixel being the calculation target.

(3) The signal processing apparatus according to (2), in which

when four blocks arranged in a vertical direction among the 16 blocks are assumed to be a column, the low pass component extraction value calculation unit is configured
to perform vertical-direction spline interpolation for each column by using representative values of the four blocks constituting the column to calculate low pass component extraction values of four positions on a horizontal line on which the pixel being the calculation target is located, and
to perform horizontal-direction spline interpolation by using the low pass component extraction values of the four positions to calculate a low pass component extraction value of the pixel being the calculation target.
   (4) The signal processing apparatus according to any one of (1) to (3), in which
the low pass component extraction value calculation unit is configured to, in the case where the pixel being the calculation target is a pixel at an end portion of an effective video area, perform spline interpolation using a representative value obtained by extrapolating a representative value of the pixel at the end portion of the effective video area based on the representative value of the block that is obtained from pixel values within the effective video area.
   (5) The signal processing apparatus according to any one of (1) to (4), in which

the low pass component extraction value calculation unit is configured to perform the spline interpolation using a representative value calculated for a video signal one frame before.

(6) The signal processing apparatus according to any one of (1) to (5), in which

the representative value calculation unit is configured to calculate an average value of luminance values of each block, as an average value of pixel values of the block.

(7) The signal processing apparatus according to any one of (1) to (5), in which

the representative value calculation unit is configured to calculate an average value of maximum absolute values of RGB signal values of each block, as an average value of pixel values of the block.

(8) The signal processing apparatus according to any one of (1) to (7), further including a gain calculation and application unit configured to apply a gain to a pixel value of the input video signal, the gain being determined based on a difference value between the pixel value of the input video signal and the low pass component extraction value at a pixel position.
(9) The signal processing apparatus according to (8), in which

the gain calculation and application unit is configured to obtain a difference value gain being a gain appropriate to the difference value, based on the difference value and a first function, and

the first function is set to suppress gains appropriate to a neighborhood of a maximum value and a neighborhood of a minimum value of the difference value.

(10) The signal processing apparatus according to (8) or (9), in which

the gain calculation and application unit is configured
to calculate a difference value gain based on the difference value between the pixel value of the input video signal and the low pass component extraction value at the pixel position and a comparison gain based on one of a maximum absolute value of an RGB signal value of the pixel position and the luminance value of the pixel position, and
to determine a gain to be applied to the input video signal, based on the difference value gain and the comparison gain.
   (11) The signal processing apparatus according to (10), in which
the gain calculation and application unit is configured to determine a smaller value of the difference value gain and the comparison gain as a gain to be applied to the input video signal.

The present disclosure contains subject matter related to that disclosed in Japanese Priority Patent Application JP 2012-154295 filed in the Japan Patent Office on Jul. 10, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing apparatus, comprising:
a representative value calculation unit configured to calculate, when areas obtained by dividing a frame image in units of a plurality of pixels are each assumed as a block, an average value of pixel values within each block as a representative value of the block based on an input video signal; and
a low pass component extraction value calculation unit configured to perform spline interpolation using the representative values of the blocks located near a pixel being a calculation target for a low pass component extraction value, to calculate the low pass component extraction value of the calculation target.

2. The signal processing apparatus according to claim 1, wherein
the low pass component extraction value calculation unit performs spline interpolation using representative values of 16 blocks of four horizontal blocks by four vertical blocks that are located near the pixel being the calculation target.

3. The signal processing apparatus according to claim 2, wherein
when four blocks arranged in a vertical direction among the 16 blocks are assumed to be a column, the low pass component extraction value calculation unit is configured
to perform vertical-direction spline interpolation for each column by using representative values of the four blocks constituting the column to calculate low pass component extraction values of four positions on a horizontal line on which the pixel being the calculation target is located, and
to perform horizontal-direction spline interpolation by using the low pass component extraction values of the four positions to calculate a low pass component extraction value of the pixel being the calculation target.

4. The signal processing apparatus according to claim 1, wherein
the low pass component extraction value calculation unit is configured to, in the case where the pixel being the calculation target is a pixel at an end portion of an effective video area, perform spline interpolation using a representative value obtained by extrapolating a representative value of the pixel at the end portion of the effective video area based on the representative value of the block that is obtained from pixel values within the effective video area.

5. The signal processing apparatus according to claim 1, wherein
the low pass component extraction value calculation unit is configured to perform the spline interpolation using a representative value calculated for a video signal one frame before.

6. The signal processing apparatus according to claim 1, wherein
the representative value calculation unit is configured to calculate an average value of luminance values of each block, as an average value of pixel values of the block.

7. The signal processing apparatus according to claim 1, wherein
the representative value calculation unit is configured to calculate an average value of maximum absolute values of RGB signal values of each block, as an average value of pixel values of the block.

8. The signal processing apparatus according to claim 1, further comprising a gain calculation and application unit configured to apply a gain to a pixel value of the input video signal, the gain being determined based on a difference value between the pixel value of the input video signal and the low pass component extraction value at a pixel position.

9. The signal processing apparatus according to claim 8, wherein
the gain calculation and application unit is configured to obtain a difference value gain being a gain appropriate to the difference value, based on the difference value and a first function, and
the first function is set to suppress gains appropriate to a neighborhood of a maximum value and a neighborhood of a minimum value of the difference value.

10. The signal processing apparatus according to claim 8, wherein
the gain calculation and application unit is configured
to calculate a difference value gain based on the difference value between the pixel value of the input video signal and the low pass component extraction value at the pixel position and a comparison gain based on one of a maximum absolute value of an RGB signal value of the pixel position and the luminance value of the pixel position, and
to determine a gain to be applied to the input video signal, based on the difference value gain and the comparison gain.

11. The signal processing apparatus according to claim 10, wherein
the gain calculation and application unit is configured to determine a smaller value of the difference value gain and the comparison gain as a gain to be applied to the input video signal.

12. A signal processing method, comprising:
calculating, when areas obtained by dividing a frame image in units of a plurality of pixels are each assumed as a block, an average value of pixel values within each block as a representative value of the block based on an input video signal; and
performing spline interpolation using the representative values of the blocks located near a pixel being a calculation target for a low pass component extraction value, to calculate the low pass component extraction value of the calculation target.
